(19) United States
(12) Patent Application Publication
(10) Pub. No.: US 2004/0217645 A1
(43) Pub. Date: Nov. 4, 2004

(54) Towed implement for operation on- and off-road

(75) Inventors: Cyrille Ponet, College Raymond Gueux (FR); Jean Viaud, Gray (FR); Emmanuel Chapon, Champvans (FR)

Correspondence Address: Jimmie R. Oaks, Patent Department, DEERE & COMPANY, One John Deere Place, Moline, IL, 61265-8098, US

(73) Assignee: Deere & Company, a Delaware corporation

(21) Appl. No.: 10/828,364

(22) Filed: Apr. 20, 2004

(30) Foreign Application Priority Data
Apr. 29, 2003 (DE) 103 19 184.4

(51) Int. Cl. B60T 13/00

(52) U.S. Cl. 303/7

(57) ABSTRACT

A towed implement for operation on roads and off-road. Known towed implements in agriculture have, e.g., pressurized air brakes which enable them to be effectively braked, particularly during travel on roads, without causing skidding of the towing tractor. However when such brakes are used off-road it is regarded as a drawback that, e.g., they cause damage to turf. As a solution to the problem of overly vigorous braking during off-road operation, a towed implement is proposed wherein the braking force is controlled so as to be of a greater magnitude during on-road operation than it is for off-road operation. For this purpose, a sensor is provided for sensing the operating condition of a component which provides a signal indicative of whether or not the implement is operating off-road or on-road, with the signal being used to control the amount of force used for braking the implement.

### FIELD OF THE INVENTION

The invention relates to a towed vehicle for on-road and off-road operation, having an adjustable application device for a brake system, and having at least one sensor for determining at least one operating state of the vehicle.

### BACKGROUND OF THE INVENTION

It is known to provide heavy towed vehicles, e.g. in agriculture, with a brake system, wherewith the wheels are braked pneumatically or hydraulically. See, e.g., “BIG PACK of KRONE” (publication code Big Pack-10304-10′-10.99 (VDV)).

### SUMMARY OF THE INVENTION

The underlying problem of the invention is that when braking in the field the turf can be damaged or the vehicle can undesirably swerve.

This problem is solved by a braking system, which includes an application device that includes at least one sensor for detecting at least one operating state of the towed vehicle.

By the braking system described, one can adjust the braking force and thereby also the point at which the wheels lock; in particular, when the sensor determines that the vehicle is in operation, one may assume that it is in field use where the above-stated problems are presented. In this case, it is not necessary to apply high brake force, because seldom is there other traffic in the field and because low speeds of travel are used during field operation of the vehicle. The subject vehicle may comprise a baler, a field chopper, a sprayer, a mower, a harvester, a saw vehicle, or any other vehicle used in field or forest agriculture. The brakes may be applied hydraulically or pneumatically. Also, a mechanical means of actuation is a possibility, e.g., based on the thrust on the towing shaft, in which case there will be a conversion relationship between the thrust force and the brake force. As will be discussed in more detail herein-below, various means may be used to detect the operating state of the vehicle. In particular, in modern machines typically a number of operating parameters are determined in the course of operation of the existing control systems. The important thing is to be able to exclude the possibility that the towed vehicle is traveling on a road and to determine that it is instead in field-operation. There are a number of possible basic designs for the sensor(s), e.g., contact-type, adjustable, contact-less, etc. The simplest type of sensor is comprised of switches which deliver only an “on” or “off” signal. In more elaborate embodiments, sensors are used which deliver qualitatively differing signals, that is to say, signals of different intensities.

Japanese Patent Application No. 2002-240700 A discloses the changing of the assistance of the brake force in a tractor in a manner which depends on the operating situation. This does not address the problem of braking of a towed vehicle along with a tractor.

The use of antilock brake systems in motor vehicles is well known. Such systems are not usable in operation on raw agricultural terrain, due to their complexity. Furthermore, the relatively small production numbers of agricultural machinery, as compared to those of motor vehicles, would make the cost of such a system prohibitive.

A sensor could be employed, e.g. in an analog circuit, which would operate directly on the brake application device and would actuate said device. Particularly for implementation of gradual control or regulation rather than a stark on-or-off control technique, or in a system jointly employing the signals from a plurality of sensors, it is advantageous for the application device to be controlled via a control system. It is appropriate for the control system to comprise a computer, disposed either on the towed vehicle or on the tractor. Alternatively other control means might be employed, such as purely hardware control means. Signals can be transmitted via customary cabling, or wirelessly or using CAN bus technology. Utilization of a control system allows modification of the signal within the control system, e.g., amplification, reduction, introduction of a lag, etc.

Because off-road operating conditions may vary substantially depending on the weather, e.g. the ground may be slippery, greasy, smooth, or hard and rocky, and may be hilly or flat, it is advantageous to have the capability for an operating person to manually influence the braking force and vary the signal sent to the brake application device.

It is possible for the sensor to provide a reliable operating signal when the sensor detects the speed and/or position and/or application force of components of the vehicle which are activated during operation of the vehicle. E.g., the sensor may detect the rotational speed of mower rotors or press rolls. If this speed is very low or zero, it may be assumed that the towed vehicle is not in operation. Obviously, the forward motion of the towed vehicle may also be utilized as a parameter. The braking force may be increased when the speed of travel is greater. The status of, e.g., a pickup, a mowing bar, blade, or the like, may be monitored, or the application force on an assembly of a sawing machine, a plow, or the like may be sensed.

In order to maintain an extended, i.e., non-jackknifed position of the tractor and towed vehicle, and to adjust the respective behavior of each, it is advantageous under certain circumstances to sense the driving status of the tractor, and to include this information in the signal formation.

In general, regulating means as well as control means may be employed to adjust the braking force.

### BRIEF DESCRIPTION OF THE DRAWINGS

An exemplary embodiment of the invention is illustrated in the drawings, which embodiment will be described in more detail herein-below.

FIG. 1 is a somewhat schematic, left-side elevational view of a tractor and towed baler combination including a brake system for the baler constructed in accordance with the principles of the present invention.

FIG. 2 is an enlarged view of the brake system schematic shown in FIG. 1.

### DESCRIPTION OF THE PREFERRED EMBODIMENT

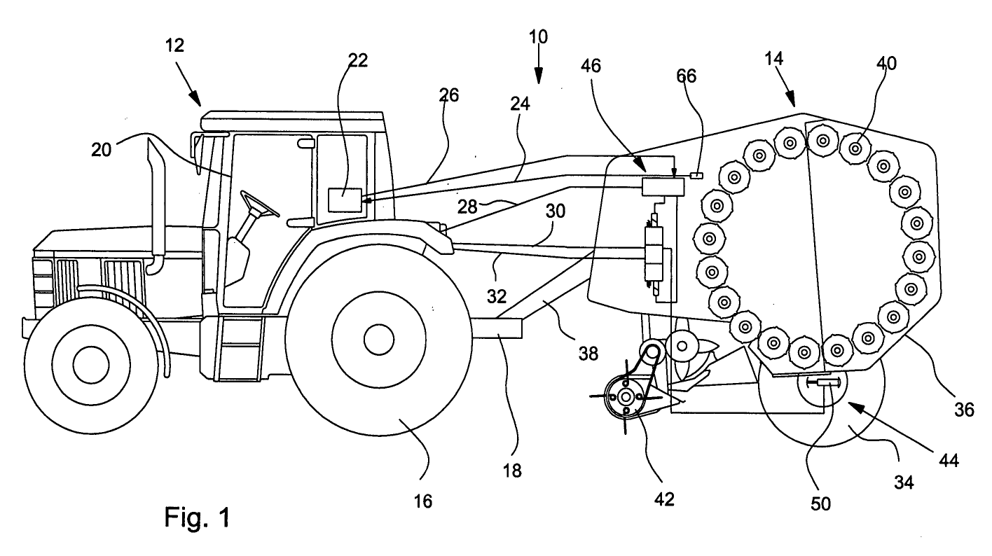

a towing vehicle 12 in the form of an ordinary farm tractor, and—a towed agricultural implement 14 [(erroneously labeled 24 in FIG. 1)], which in the particular embodiment illustrated is a circular bailing press.

The tractor and towed implement combination 10 illustrated in FIG. 1 is comprised of a towing vehicle 12, in the form of an ordinary farm tractor, and a towed agricultural implement 14, illustrated here as a large round baler.

The tractor 12 has wheels 16, which may be braked, a trailer coupling 18, a driver's cabin 20, and means (not shown) for furnishing electrical energy as well as hydraulic or pneumatic energy. To connect the tractor 12 and towed implement 14 in a control context, an operating unit 22 is provided in the area of the driver's cabin 20. An input signal line 24, an output signal line 26, a current line 28, a pressure line 30, and a return line 32, extend between the tractor 12 and the towed implement 14. The operating unit 22 can serve to receive adjustments from an operating person and also to receive signals and process them, generate displays, generate outputs, etc.

The towed implement 14 illustrated is intended to generically represent any of a number of possible implements such as those mentioned hereinabove, for use and travel off-road on general terrain (including agricultural fields or grass) or travel on-road. Since the particular type of vehicle is not an important factor in the discussion, only the components which are relevant to the essence of the invention will be described here. The towed implement 14 has wheels 34, a chassis 36, a towbar 38, a baling chamber 40, a materials pick-up and feeder 42, a brake system 44, and a control system 46.

The wheels 34 ordinarily are not driven, but they can be braked via the brake system 44, as will be described.

The chassis 36 is borne on the wheels 34 and is connected via the towbar 38 to the trailer coupling 18 of the tractor 12.

A plurality of fixed rolls 40 are arranged in a circular pattern so as to define a fixed baling chamber. The fixed rolls 40 are rotationally driven during the operation of the implement 14.

The materials pick-up 42 is drivable and is height-adjustable. During road travel, the pick-up 42 is held in a raised position and is out of operation.

The rolls 40 and the materials pick-up 42 are intended to generically represent components which are sources of sensor readings, or the like, to indicate whether the towed implement 14 is in operation or not, for example.

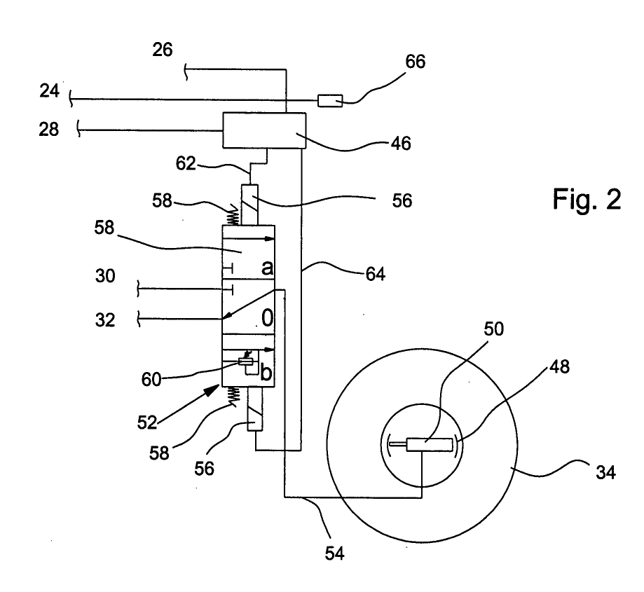

Referring now also to FIG. 2, it can be seen that the brake system 44 includes one or more brakes 48 which act on the wheels 34. The brakes 48 are actuated by an application device 50, which is in the form of a mechanical application device which operates by simple means, e.g. a hydraulic cylinder, and receives pressurized fluid and can return such fluid, via a valve 52 and a line 54.

The valve 52 may have three different settings (0, a, and b). Positions a and b are brought about by two controllable electromagnets 56, 56; and the middle position 0 is brought about via two springs 58, 58 when the electromagnets 56, 56 are not activated. On the side of the brake 48, in each position of the valve 52, only one connection is provided; on the opposite side of the valve 52, a connection for the pressure line 30 and a connection for the return line 32 are provided. The pressure line 30 and return line 32 are connected to a braking system (not shown) on the tractor 12, such that pressure can only be applied or reduced when the braking system on the tractor 12 is being actuated. When the valve is in position 0, the application device 50 is connected only with the return line 32 which in turn is connected with the reservoir container (not shown), and thus the brake 48 is not actuated. When the valve is in position a, a direct connection is produced between the pressure line 30 and the application device 50, so that the pressure in the pressure line 30 is applied to the brake 48 and the brake is applied to the wheel 34.

In the position b, the pressure line 30 is connected to the return line 32 via an adjustable pressure regulating valve 60, so that the pressure applied to the application device 50 does not correspond to the pressure which prevails in the pressure line 30 but rather to a pressure dependent on the pressure regulating valve 60.

The control system 46 is connected on its input side to the current line 28 and the output signal line 26 from the tractor 12, and is connected on its output side to a total braking signal line 62 and a partial braking signal line 64. The current line connection 28 serves only to provide power for the operation of the control system 46, whereas the output signal line 26 serves to provide signals from the operating unit 22 to the control system. Such signals may originate from the sensor 66, which senses whether the baling chamber rolls 40 and/or the materials pick-up 42 is/are in operation or not, and whether the towed implement 14 can be towed on a road or whether due to being in operation it can only be operated in a field, i.e., off-road. Further, the operating unit 22, adjusted manually or automatically, can serve to influence the signal formed in the control system, as to the magnitude, rate, or the like, of the signal. Basically the sensor 66 can also be connected directly to the control system 46 or even to the valve 52. However, because for other reasons, ordinarily there will already be a connection between the sensor 66 and the operating unit 22 and this connection can be used to advantage. In any event, the control system 46 generates a signal which results in the valve 52 assuming one of its positions (0, a, b).

The following functioning results.

As soon as the tractor and towed vehicle 10 is traveling on a road, the sensor 66 determines that the towed implement 14 is not in operation, in that the baling chamber rolls 40 and materials pick-up 42 are not in operation, i.e., are in a stopped state. Accordingly, a signal is generated in the control system and is sent out, which signal causes the valve 52 to be moved into position a by means of the top electromagnet 56 (FIG. 2) powered by the total braking signal line 62. As soon as the brake system of the tractor 12 is actuated, the entire pressure can be applied to the application device 50 and thus to the brake 48. The wheels 34 are braked with the greatest possible force or energy, in the case of road travel.

If, in contrast, the sensor 66 detects that the towed vehicle is in operation, e.g., because the materials pick-up 42 is in rotation, it is assumed that the towed implement 14 is in the field, and therefore high braking force is neither necessary nor desirable. In this case the control system 46 causes the valve 52 to be positioned in valve position b in which position part of the pressure is dissipated via the pressure regulating valve 60 when the brake system of the tractor 12 is actuated. This pressure does not cause the wheels 34 to lock or swerve to the side, or at least it diminishes the intensity and speed of such effects compared to what would occur if the full pressure were applied. To the extent that the pressure regulating valve 60 is adjustable and can receive a signal from the control system 46, e.g. via a line 64, it is also possible to change the setting of the pressure regulating valve 60 and thereby increase or decrease the braking pressure.

The characteristics of the hydraulic system and the type of control of the pressure on the application device 50 are freely selectable. There is no need to adhere to the illustrated embodiment, which is presented merely as an exemplary embodiment.

Having described the preferred embodiment, it will become apparent that various modifications can be made without departing from the scope of the invention as defined in the accompanying claims.

1. In a towed implement for operation on-road and off-road and including: at least one ground wheel, a braking system having an application device associated with said ground wheel and operative in response to an application force to apply a braking force, which corresponds to said application force, to said ground wheel, and at least one sensor for detecting at least one operating state of the towed vehicle, the improvement comprising: said at least one sensor being coupled to said braking system and being operative for causing said application force to change upon receiving a signal from said at least one sensor.

2. The towed implement, as defined in claim 1, and further including a control system coupled between said at least on sensor and said braking system; and said control system influencing operation of said application device in response to a signal received from said at least one sensor.

3. The towed implement, as defined in claim 1, wherein said control system includes a manually adjustable device for causing said application device to apply a different force to said at least one wheel during road operation of said implement than what it does during off-road operation of said implement.

4. The towed implement, as defined in claim 1, wherein said implement further includes at least one actuated component which is normally in a first condition when said implement is traveling on-road, and in a second condition when said implement is traveling off-road; and said at least one sensor senses whether said actuated component is in said first or said second condition.
